(19) United States
(12) Patent Application Publication
(10) Pub. No.: US 2022/0195788 A1
(43) Pub. Date: Jun. 23, 2022

(54) ANTI-MOSQUITO AND ANTI-HAZE PURIFICATION WINDOW EMBEDDED WITH VENTILATION SYSTEM

(71) Applicant: Dalian University of Technology, Dalian (CN)

(72) Inventors: Yang Lv, Dalian (CN); Rui Zhu, Dalian (CN)

(21) Appl. No.: 17/210,495

(22) Filed: Mar. 23, 2021

(30) Foreign Application Priority Data
Dec. 22, 2020 (CN) 202011525251.3

(51) Int. Cl. E06B 7/08; F24F 13/18

(52) U.S. Cl. CPC E06B 7/08; E06B 2007/023; F24F 13/18

(57) ABSTRACT

A purification window embedded with a ventilation system, including: a window frame, and a double-layered glass window unit arranged in the window frame. An outdoor window screen roll and an indoor window screen roll are arranged at a left stile and a right stile, respectively. An upper middle position and a lower middle position of the double-layered glass window unit are respectively in rotational connection with a top rail via an upper shaft and a bottom rail via a lower shaft. The ventilation system includes: an air supply chamber and an exhaust chamber, both of which provided therein with T-shaped air dampers and fans. Both external edges of the outdoor window screen roll and the indoor window screen roll are provided with magnetic tapes configured for fixation connection with the upper shaft and the lower shaft.

### CROSS-REFERENCE TO RELATED APPLICATIONS

Pursuant to 35 U.S.C. § 119 and the Paris Convention Treaty, this application claims the benefit of Chinese Patent Application No. 202011525251.3 filed Dec. 22, 2020, the contents of which are incorporated herein by reference.

### BACKGROUND OF THE INVENTION

### Field of the Invention

The present application relates to the technical field of fresh air purification, and particularly to an anti-mosquito and anti-haze purification window embedded with a ventilation system, and more particularly to a window structure which is capable of realizing anti-mosquito capability and different states of the ventilation system according to indoor and outdoor air and meteorological conditions.

### Description of the Related Art

In recent years, outdoor haze and urban acoustic pollution have becoming severe. At the same time, outdoor flying insects not only affect people's work, study, and sleep, but more importantly, they can spread diseases, such as malaria, Japanese encephalitis, filariasis, and dengue fever. etc. For urban buildings, the cleaning function of exterior windows is extremely important. Therefore, vertical pivot windows have broad prospects, but their special opening methods make it difficult to design the mosquito screen windows, thus limiting the application thereof. In addition, due to the needs of indoor lighting, purification, and ventilation, the purification window that combines the pollution purification and the ventilation has emerged.

The existing window-type electric ventilation system is provided therein with a cross-flow fan, when being started, such type of electric ventilation system will enter a mechanical ventilation mode. Although the need of refreshing the indoor air is satisfied, the starting of the mechanical ventilation mode would result in waste of the power resources, particularly when the outdoor wind is relatively strong and the strong mechanical ventilation demand is not necessary.

### SUMMARY

In view of the above technical problems, it is an objective of the present application to provide an anti-mosquito and anti-haze purification window embedded with a ventilation system which solved the problems the existing window-type electric ventilation system only has single mode and is not energy-saving.

To achieve the above objectives, in accordance with one embodiment of the invention, there is provided a purification window embedded with a ventilation system. The purification window comprises: a window frame, being a rectangular frame formed by a top rail, a bottom rail, a left stile, and a right stile; and a double-layered glass window unit, arranged in the window frame, and being an enclosed structure defining a cavity therein and formed by an indoor side glass, an outdoor side glass, and sealing strips. An outdoor window screen roll is arranged at the left stile, and an indoor window screen roll is arranged at the right stile. An upper middle position of the double-layered glass window unit is in rotational connection with the top rail via an upper shaft made of a magnetic material. A lower middle position of the double-layered glass window unit is in rotational connection with the bottom rail via a lower shaft made of a magnetic material.

The ventilation system is arranged above the window frame and comprises: an air supply chamber, an air isolation chamber, and an exhaust chamber. A first rainproof grille is arranged at an air supply port at an outdoor side of the air supply chamber. A first T-shaped air damper in connection with a first electromagnetic actuator is arranged in the air supply chamber. A blower is arranged in the air supply chamber, where an air outlet of the blower is arranged at an indoor side of the air supply chamber, and an air inlet of the blower is provided therein with a filter. A second rainproof grille is arranged at an exhaust port at an outdoor side of the exhaust chamber. A second T-shaped air damper in connection with a second electromagnetic actuator is arranged in the exhaust chamber. An exhaust fan is arranged in the exhaust chamber, where an air inlet of the exhaust fan is arranged at an indoor side of the exhaust chamber, and an air outlet of the exhaust fan is provided therein with a filter.

A left accommodation box a is arranged at a left side of the left stile and is configured for accommodating the outdoor window screen roll, and a right accommodation box b is arranged at a right side of the right stile and is configured for accommodating an indoor window screen roll. Both external edges of the outdoor window screen roll and the indoor window screen roll are provided with magnetic tapes configured for fixation connection with the upper shaft and the lower shaft.

The purification window further comprises a controller, and the controller is configured for electric connection with the first electromagnetic actuator, the second electromagnetic actuator, the indoor multi-parameter sensor, the outdoor multi-parameter sensor, the blower, the exhaust fan, an indicator light, and a buzzer.

In a class of this embodiment, the controller is an S7-200 PLC controller.

In a class of this embodiment, the indoor multi-parameter sensor comprises: a CO₂ sensor, a CO sensor, a PM2.5 sensor, and a formaldehyde sensor. The outdoor multi-parameter sensor comprises: a rainfall sensor, a wind speed sensor, and a PM2.5 sensor. A rain baffle is arranged above the outdoor multi-parameter sensor.

In a class of this embodiment, the double-layered glass window unit is filled therein with a dry gas, and a desiccant is disposed at a bottom of the double-layered glass window unit.

In a class of this embodiment, both the first rainproof grille and the second rainproof grille adopt ventilation and rainproof louvers.

In a class of this embodiment, the first electromagnetic actuator and the second electromagnetic actuator are driving mechanisms, and each driving mechanism electromagnetic is formed by a coil, an armature, and a return spring.

Advantages of the purification window embedded with the ventilation system according to embodiments of the present application are summarized as follows: the purification window is embedded with the ventilation system. The purification window comprises: the window frame, and the double-layered glass window unit arranged in the window frame. The outdoor window screen roll is arranged at the left stile, and the indoor window screen roll is arranged at the right stile. The upper middle position of the double-layered glass window unit is in rotational connection with the top rail via the upper shaft made of the magnetic material. The lower middle position of the double-layered glass window unit is in rotational connection with the bottom rail via the lower shaft made of the magnetic material. The ventilation system is arranged above the window frame and comprises: the air supply chamber, the air isolation chamber, and the exhaust chamber. The first T-shaped air damper in connection with the first electromagnetic actuator is arranged in the air supply chamber. The second T-shaped air damper in connection with the second electromagnetic actuator is arranged in the exhaust chamber. The blower is arranged in the air supply chamber and the exhaust fan is arranged in the exhaust chamber. Both external edges of the outdoor window screen roll and the indoor window screen roll are provided with magnetic tapes configured for fixation connection with the upper shaft and the lower shaft. The purification window further comprises the controller, and the controller is configured for electric connection with the first electromagnetic actuator, the second electromagnetic actuator, the indoor multi-parameter sensor, the outdoor multi-parameter sensor, the blower, the exhaust fan, the indicator light, and the buzzer. The effect of the purification window is to enhance air circulation and achieve purification of the indoor air in multiple states, which can effectively solve the current problems that vertical turning window units cannot effectively prevent mosquitoes and cannot filter atmospheric particle pollution.

### BRIEF DESCRIPTION OF THE DRAWINGS

The invention is described hereinbelow with reference to the accompanying drawings, in which:

FIG. 1 is a perspective view anti-mosquito and anti-haze purification window embedded with a ventilation system viewed from an inclined 45° angle according to an embodiment of the present application;

FIG. 2 is an anti-mosquito and anti-haze purification window embedded with a ventilation system viewed from outdoor to indoor according to an embodiment of the present application;

FIG. 3 is an anti-mosquito and anti-haze purification window embedded with a ventilation system viewed from indoor to outdoor according to an embodiment of the present application;

FIG. 4 is a top view of the ventilation system in an on-state according to an embodiment of the present application;

FIG. 5 is a top view of the ventilation system in an off-state according to an embodiment of the present application;

FIG. 6 is a detail of a side view of the ventilation system in the on-state arranged above the window unit according to an embodiment of the present application;

FIG. 7 is a detail of a side view of the ventilation system in the off-state arranged above the window unit according to an embodiment of the present application;

FIG. 8 is a top view showing natural ventilation of the window unit; and

FIG. 9 is a principle diagram of an SP-200PLC controller.

In the drawings, the following reference numbers are used:
1a. Upper shaft; 1b. Lower shaft; 2a. Indoor side glass; 2b. Outdoor side glass; 2c. Sealing strip; 3a. Top rail; 3b. Bottom rail; 3c. Left stile; 3d. Right stile; 4a. Outdoor window screen roll; 4b. Indoor window screen roll; 5a. First rainproof grille; 5b. Second rainproof grille; 6a. First electromagnetic; 6b. Second electromagnetic actuator; 7a. Blower; 7b. Exhaust fan; 8. Filter; 9. Dry gas; 10. Desiccant; 11. Air supply chamber; 12. Exhaust chamber; 13. Air isolation chamber; 14. Indoor multi-parameter sensor; 15. Outdoor multi-parameter sensor; 16. Rain baffle; 17. T-shaped air damper; 18a. Left accommodation box; 18b. Right accommodation box; 19. Air supply port; 20. Exhaust port; 21. Controller; and 22. Magnetic tapes.

### DETAILED DESCRIPTION OF THE EMBODIMENTS

The present application will be further described below with reference to the drawings:

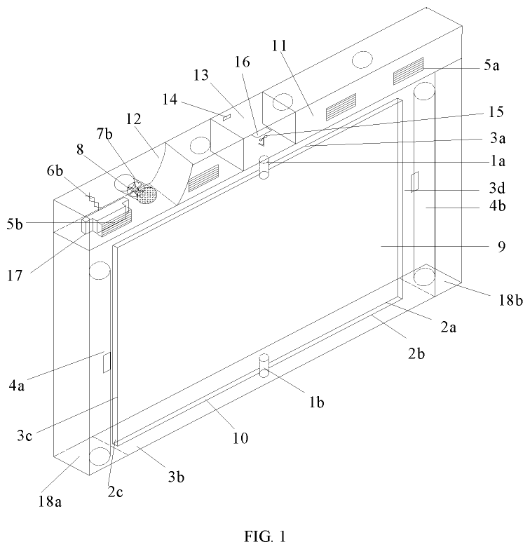

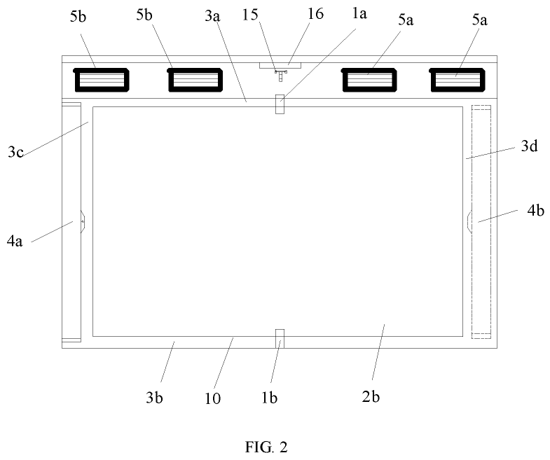

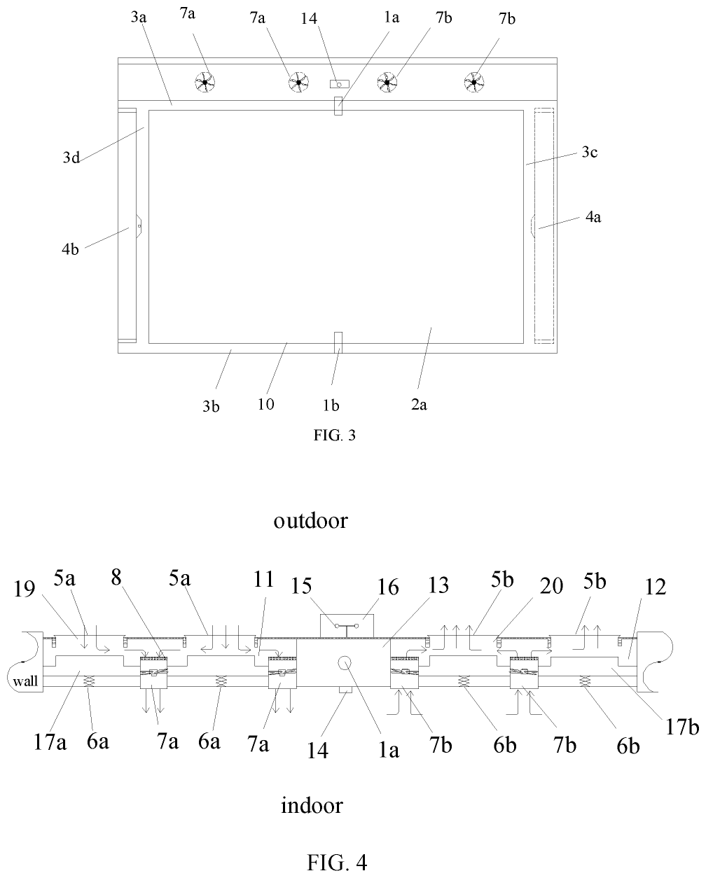

FIGS. 1-5 show structural views of an anti-mosquito and anti-haze purification window embedded with a ventilation system. In the figures, the purification window comprises: a window frame, layers of glasses, filters 8, the ventilation system, blowers 7a, exhaust fans 7b, and window screen rolls 4a, 4b. A main body of the purification window includes a rectangular arrangement formed by the ventilation system, a top rail 3a, a bottom rail 3b, a left stile 3c, and a right stile 3d. The window unit is rotatable around a vertical axis via an upper shaft 1a and a lower shaft 1b. Both the upper shaft 1a and the lower shaft 1b are made of strong magnetic materials, and the upper and the lower ends of the outer edges of the window screen rolls along the direction of the shafts can be fixed by the magnetic materials after the window screen rolls are unfolded.

The window unit is a double-glazed unit which adopts an indoor side glass 2a and an outdoor side glass 2b. A high-strength and high-air-tight composite adhesives is applied around the two layers of glass to bond and seal the two layers of glass together with sealing strips 2c and glass strips. A dry gas 9 is filled in the middle and a desiccant 10 is placed at the bottom, thus ensuring the dryness of the air between the two layers of glass.

The purification window of the present application is equipped with a roller type magnetic window screen. Invisible screen window rolls are installed at the corresponding indoor and outdoor positions. The vertical shafts of the purification window are made of magnetic materials. The window screens of the roller type arranged in a right accommodation box 18b and a left accommodation box 18a can be drawn out separately and outer edges of the window screen rolls can be in fixed connection with the vertical shafts via magnetic tapes 22 at the outer edges. The window screen includes a right part and a left part, the two parts of the window screen are drawn out from respective window screen rollers of the right accommodation box 18b and the left accommodation box 18a and are combined at a middle to ensure comprehensive mosquito prevention. The accommodation boxes configured for accommodating the screen window rolls are arranged in a concaved manner beside the left stile 3c and the right stile 3d, respectively, and both the accommodation boxes are arranged vertically. The accommodation boxes are respectively arranged at positions of an outdoor left side and an indoor right side, respectively. The outdoor window screen roll 4a and the indoor window screen roll 4b are respectively arranged inside the left accommodation box 18a and the right accommodation box 18b. In order to ensure the convenience and aesthetics of the screen window when the window unit is turned to open, the main part of the shaft of the screen window roll is received inside the window frame, and only the screen window handrail is exposed. In this way, when the screen windows are retraced, no additional space is taken up, and the anti-corrosion effect and the dust-proof effect can be achieved.

A specially designed mechanical ventilation system is arranged above the window unit and does not rotate along with the window unit. The ventilation system has three chambers, that is, an air supply chamber 11, an exhaust chamber 12, and an air isolation chamber 13. Two blowers 7a of the same model are arranged in the air supply chamber 11, and two exhaust fans 7b of the same model are arranged in the exhaust chamber 12. In order to prevent the air flows from being chaotic, the air isolation chamber 13 is configured to separate the blowers 7a of the air supply chamber 11 from the exhaust fans 7b of the exhaust chamber 12, thus making the air flow unidirectionally. The fan ducts arranged in the proximity of the outdoor side are provided therein with filters 8. Outdoor air enters the room through the first rainproof grille 5a, and the indoor return air is discharged to the outside through the second rainproof grille 5b.

The ventilation system is equipped with a first electromagnetic actuator 6a and a second electromagnetic actuator 6b, which are configured to mechanically drive the ventilation system to open and close by receiving signals from the controller 21. The indoor multi-parameter sensor 14 comprises: a CO₂ sensor, a CO sensor, a PM2.5 sensor, and a formaldehyde sensor, which are located at corresponding positions at an indoor side of the air isolation chamber 13. The outdoor multi-parameter sensor 15 comprises: a rainfall sensor, a wind speed sensor, and a PM2.5 sensor, which are located at corresponding positions at an outdoor side of the air isolation chamber 13.

FIG. 4 is a top view of the ventilation system in an on-state according to an embodiment of the present application. When it is detected by the indoor multi-parameter sensor 14 that at least one of the indoor CO₂, CO, PM2.5, and formaldehyde concentrations is higher than a preset value and it is detected by the outdoor multi-parameter sensor 15 that the PM2.5 concentration is higher than the preset value and it is a rainy day; then, the window unit is manually closed, and the ventilation system is opened, and if the wind speed monitored by the wind speed sensor is lower than a preset value, then the blower 7a and the exhaust fan 7b are started to enter a mechanical ventilation mode of the ventilation system. The first electromagnetic actuator 6a and the second electromagnetic actuator 6b are controlled by the controller to open the first T-shaped air damper 17a and the second T-shaped air damper 17b. The outdoor air enters the air supply chamber 11 through the first rainproof grilles 5a, then filtered by the filters 8 arranged at the blowers 7a and enters the indoor space; the indoor air enters the exhaust fan 7b, then filtered by the filters 8 arranged at the exhaust fans 7b and enters the exhaust chamber 12, and finally discharged to the outdoor space through the second rainproof grilles 5b.

The S7-200 PLC controller model 6ES7211-0BA23-0XB0, AC/DC/relay is a micro PLC, which is applicable for different fields and industries, particularly in automatic detection, monitoring, and control in various occasions, the S7-200 PLC controller can realize its complex control function due to its powerful functions, regardless of whether it is running in a stand-alone manner or connected into a network.

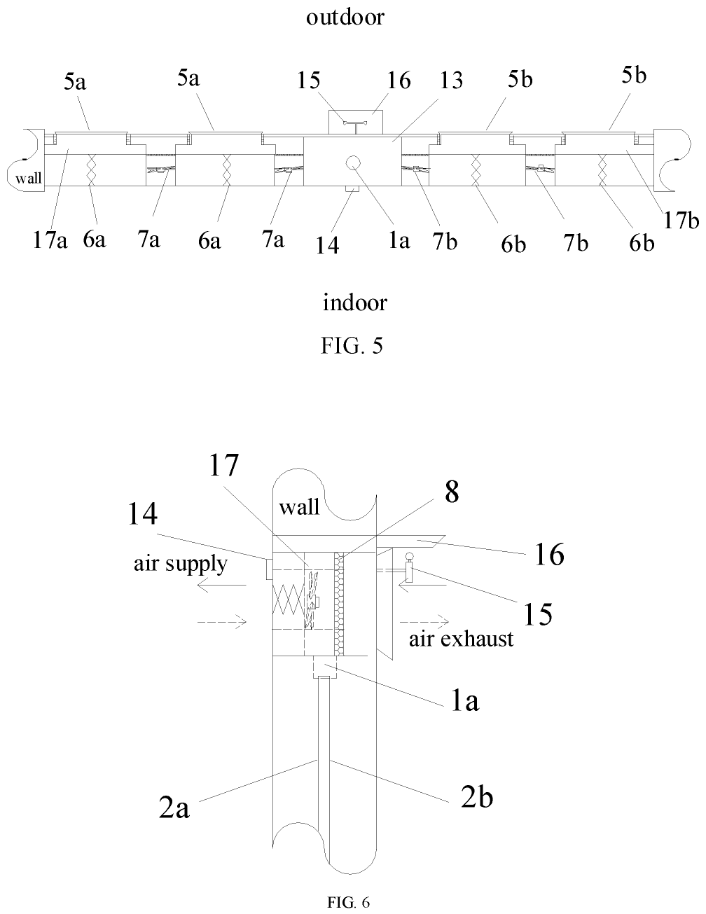

FIG. 5 is a top view of the ventilation system in an off-state according to an embodiment of the present application. When it is detected by the indoor multi-parameter sensor 14 that at least one of the indoor CO₂, CO, PM2.5, and formaldehyde concentrations is higher than the preset value and it is detected by the outdoor multi-parameter sensor 15 that the PM2.5 concentration is lower than the preset value and it is a sunny day; then, the window unit is manually opened, and the ventilation system is turned off. The first electromagnetic actuators 6a and the second electromagnetic actuators 6b are controlled by the controller to push the first T-shaped air dampers 17a and the second T-shaped air dampers 17b to close the air supply ports 19 and the exhaust ports 20, thereby closing the corresponding air ducts.

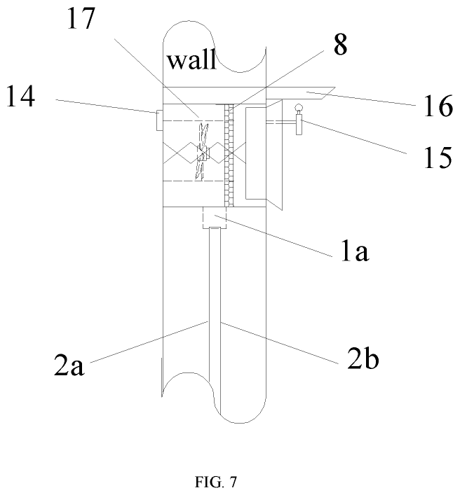

FIGS. 6-7 show details of a side view of the ventilation system in the on-state and the off-state according to embodiments of the present application. A rain baffle 16 is arranged above the outdoor multi-parameter sensor 15. When the ventilation system is turned on, the first T-shaped air dampers 17a and the second T-shaped air dampers 17b are retracted towards an indoor side by the first electromagnetic actuators 6a and the second electromagnetic actuators 6b, so as to open the air supply chamber 11 and the exhaust chamber 12. When the ventilation system is turned off, the first T-shaped air damper 17a and the second T-shaped air damper 17b are pushed by the first electromagnetic actuators 6a and the second electromagnetic actuators 6b to close the air supply chamber 11 and the exhaust chamber 12.

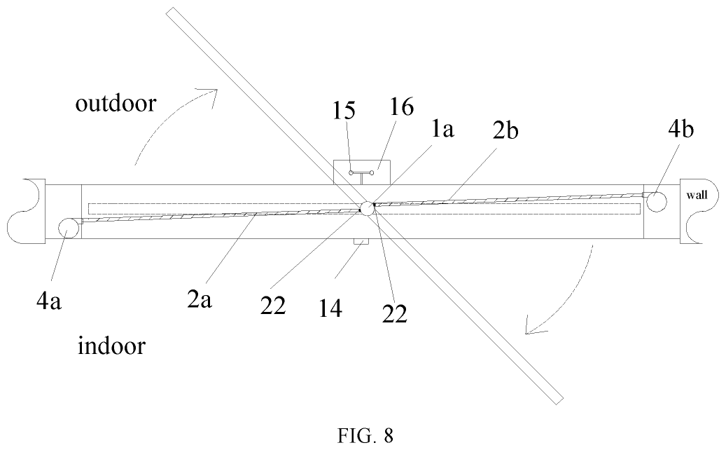

FIG. 8 shows a top view of anti-mosquito and anti-haze embedded with the ventilation system when the window unit is opened for natural ventilation. For the natural ventilation, when the window unit is opened perpendicular to the window sill, the outdoor window screen roll 4a and the indoor window screen roll 4b are extended and in fixed connection with the upper shaft 1a and the lower shaft 1b via the magnetic tapes 22 arranged at the edges of the screen window rolls, in such condition, the window unit can be rotated counterclockwise at any angle to change the opening degree.

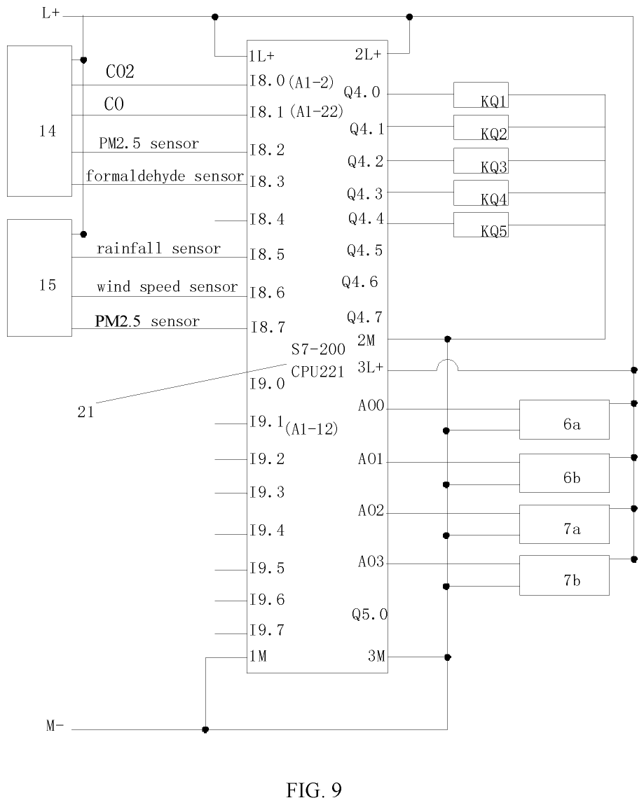

FIG. 9 shows the principle diagram of the SP-200 PLC controller. The PLC controller is in electric connection with the first electromagnetic actuator 6a, the second electromagnetic actuator 6b, the indoor multi-parameter sensor 14, the outdoor multi-parameter sensor 15, the blowers 7a, and the exhaust fans 7b, the indicator light, and the buzzer. The ventilation method used in the purification window are specifically as follows:

a. Natural Ventilation Mode of the Window Unit

when it is determined by the controller that at least one of the indoor CO₂, CO, PM2.5, and formaldehyde concentrations detected by the indoor multi-parameter sensor 14 is higher than a preset value and the PM2.5 concentration detected by the outdoor multi-parameter sensor 15 is lower than the preset value, a sunny day is detected by a rainfall sensor at outdoor, and the indicator light flashes and the buzzer prompts; the first electromagnetic actuators 6a and the second electromagnetic actuators 6b are controlled by the controller 21 to close the first T-shaped air dampers 17a and the second T-shaped air dampers 17b, and at the same time, the blowers 7a and the exhaust fans 7b are turned off by the controller 21, the window unit is manually rotated to open and the indoor window screen roll 4b and the outdoor window screen roll 4a are unfolded, and each of the magnetic tapes 22 of the indoor window screen roll 4b and the outdoor window screen roll 4a are fixed to the upper shaft and the lower shaft, whereby realizing the natural ventilation of the window unit.

b. Natural Ventilation Mode of the Ventilation System

when it is determined by the controller that at least one of the indoor CO₂, CO, PM2.5, and formaldehyde concentrations detected by the indoor multi-parameter sensor 14 is higher than a preset value and the PM2.5 concentration detected by the outdoor multi-parameter sensor 15 is higher than the preset value, a rainy day is detected by the rainfall sensor at outdoor, and the buzzer prompts; the indoor window screen roll 4b and the outdoor window screen roll 4a are manually folded, the window unit is closed, the ventilation system is started, the first electromagnetic actuators 6a and the second electromagnetic actuators 6b are controlled by the controller to open the first T-shaped air dampers 17a and the second T-shaped air dampers 17b. And if it is detected by the wind speed sensor that the wind speed is higher than a preset value, the natural ventilation mode of the ventilation system is entered, in the absence of starting the blowers 7a or the exhaust fans 7b.

c. Mechanical Ventilation Mode of the Ventilation System

when it is determined by the controller that at least one of the indoor CO₂, CO, PM2.5, and formaldehyde concentrations detected by the indoor multi-parameter sensor 14 is higher than a preset value and the PM2.5 concentration detected by the outdoor multi-parameter sensor 15 is higher than the preset value, a rainy day is detected by the rainfall sensor at outdoor, and the buzzer prompts; the indoor window screen roll 4b and the outdoor window screen roll 4a are manually folded, the window unit is closed, the ventilation system is started, the first electromagnetic actuators 6a and the second electromagnetic actuators 6b are controlled by the controller to open the first T-shaped air dampers 17a and the second T-shaped air dampers 17b. And if it is detected by the wind speed sensor that the wind speed is lower than a preset value, the blowers 7a and the exhaust fans 7b are started to enter a mechanical ventilation mode of the ventilation system.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A purification window embedded with a ventilation system, the purification window comprising:
a window frame, being a rectangular frame formed by a top rail (3a), a bottom rail (3b), a left stile (3c), and a right stile (3d); and
a double-layered glass window unit, arranged in the window frame, and being an enclosed structure defining a cavity therein and formed by an indoor side glass (2a), an outdoor side glass (2b), and sealing strips (2c);
wherein
an outdoor window screen roll (4a) is arranged at the left stile (3c), and an indoor window screen roll (4b) is arranged at the right stile (3d);
an upper middle position of the double-layered glass window unit is in rotational connection with the top rail (3a) via an upper shaft (1a) made of a magnetic material; a lower middle position of the double-layered glass window unit is in rotational connection with the bottom rail (3b) via a lower shaft (1b) made of a magnetic material;
the ventilation system is arranged above the window frame and comprises: an air supply chamber (11), an air isolation chamber (13), and an exhaust chamber (12);
a first rainproof grille (5a) is arranged at an air supply port (19) at an outdoor side of the air supply chamber (11), a first T-shaped air damper (17a) in connection with a first electromagnetic actuator (6a) is arranged in the air supply chamber (11); a blower (7a) is arranged in the air supply chamber (11), wherein, an air outlet of the blower (7a) is arranged at an indoor side of the air supply chamber (11), and an air inlet of the blower (7a) is provided therein with a filter (8);
a second rainproof grille (5b) is arranged at an exhaust port (20) at an outdoor side of the exhaust chamber (12), a second T-shaped air damper (17a) in connection with a second electromagnetic actuator (6b) is arranged in the exhaust chamber (12); an exhaust fan (7b) is arranged in the exhaust chamber (12), wherein, an air inlet of the exhaust fan (7b) is arranged at an indoor side of the exhaust chamber (12), and an air outlet of the exhaust fan (7b) is provided therein with a filter (8);
a left accommodation box (18a) is arranged at a left side of the left stile (3c) and is configured for accommodating the outdoor window screen roll (4a), and a right accommodation box (18b) is arranged at a right side of the right stile (3d) and is configured for accommodating an indoor window screen roll (4b); both external edges of the outdoor window screen roll (4a) and the indoor window screen roll (4b) are provided with magnetic tapes (22) configured for fixation connection with the upper shaft (1a) and the lower shaft (1b); and
the purification window further comprises a controller (21), and the controller (21) is configured for electric connection with the first electromagnetic actuator (6a), the second electromagnetic actuator (6b), an indoor multi-parameter sensor (14), an outdoor multi-parameter sensor (15), the blower (7a), the exhaust fan (7b), an indicator light, and a buzzer.

2. The purification window according to claim 1, wherein the controller (21) is an S7-200 PLC controller.

3. The purification window according to claim 1, wherein the indoor multi-parameter sensor (14) comprises: a CO₂ sensor, a CO sensor, a PM2.5 sensor, and a formaldehyde sensor; the outdoor multi-parameter sensor (15) comprises: a rainfall sensor, a wind speed sensor, and a PM2.5 sensor; and a rain baffle (16) is arranged above the outdoor multi-parameter sensor (15).

4. The purification window according to claim 1, wherein the double-layered glass window unit is filled therein with a dry gas (9), and a desiccant (10) is disposed at a bottom of the double-layered glass window unit.

5. The purification window according to claim 1, wherein both the first rainproof grille (5a) and the second rainproof grille (5b) adopt ventilation and rainproof louvers.

6. A ventilation method using the purification window according to claim 1, comprising:
a. a natural ventilation mode of the window unit, wherein the natural ventilation mode of the window unit comprises the following steps:
controlling, by the controller, the first electromagnetic actuator (6a) and the second electromagnetic actuator (6b) to close the first T-shaped air damper (17a) and the second T-shaped air damper (17b), and simultaneously turning off, by the controller, the blower (7a) and the exhaust fan (7b), manually rotating and opening the window unit and unfolding the indoor window screen roll and the outdoor window screen roll, and fixing each of the magnetic tapes (22) of the indoor window screen roll and the outdoor window screen roll to the upper shaft and the lower shaft, whereby realizing the natural ventilation of the window unit, when it is determined by the controller that at least one of the indoor CO₂, CO, PM2.5, and formaldehyde concentrations detected by the indoor multi-parameter sensor (14) is higher than a preset value and the PM2.5 concentration detected by the outdoor multi-parameter sensor (15) is lower than the preset value, a sunny day is detected by a rainfall sensor at outdoor, and the indicator light flashes and the buzzer prompts;
b. a natural ventilation mode of the ventilation system, wherein the natural ventilation mode of the ventilation system comprises the following steps:
manually folding the indoor window screen roll and the outdoor window screen roll, closing the window unit, starting the ventilation system, and controlling, by the controller, the first electromagnetic actuator (6a) and the second electromagnetic actuator (6b) to open the first T-shaped air damper (17a) and the second T-shaped air damper (17b), when it is determined by the controller that at least one of the indoor CO₂, CO, PM2.5, and formaldehyde concentrations detected by the indoor multi-parameter sensor (14) is higher than a preset value and the PM2.5 concentration detected by the outdoor multi-parameter sensor (15) is higher than the preset value, a rainy day is detected by the rainfall sensor at outdoor, and the buzzer prompts; and
directly entering the natural ventilation mode of the ventilation system in the absence of starting the blower (7a) or the exhaust fan (7b) when a wind speed detected by a wind speed sensor is higher than a preset value; and
c. a mechanical ventilation mode of the ventilation system, wherein the mechanical ventilation mode of the ventilation system comprises the following steps:
manually folding the indoor window screen roll and the outdoor window screen roll, closing the window unit, starting the ventilation system, and controlling, by the controller, the first electromagnetic actuator (6a) and the second electromagnetic actuator (6b) to open the first T-shaped air damper (17a) and the second T-shaped air damper (17b), when it is determined by the controller that at least one of the indoor CO₂, CO, PM2.5, and formaldehyde concentrations detected by the indoor multi-parameter sensor (14) is higher than a preset value and the PM2.5 concentration detected by the outdoor multi-parameter sensor (15) is higher than the preset value, a rainy day is detected by the rainfall sensor at outdoor, and the buzzer prompts; and
starting the blower (7a) and the exhaust fan (7b) to enter a mechanical ventilation mode of the ventilation system when a wind speed detected by a wind speed sensor is lower than a preset value.
